(19) United States
(12) Patent Application Publication
(10) Pub. No.: US 2011/0318596 A1
(43) Pub. Date: Dec. 29, 2011

(54) HIGH PEEL STRENGTH ARTICLE COMPRISING A THERMOPLASTIC-METAL INTERPENETRATED VOLUME

(76) Inventors: ANDRI ELIA ELIA, Chads Ford, PA (US); JUAN CARLOS FIGUEROA, Wilmington, DE (US); CHARLES DUBOIS, Wilmington, DE (US); CLAUDIO PIERDOMENICO, (US); MARIANE ZEBRI, Cruseilles (FR)

(21) Appl. No.: 12/824,129

(22) Filed: Jun. 25, 2010

(51) Int. Cl. B32B 7/04; B05D 3/10; B32B 15/088

(52) U.S. Cl. 428/545; 428/308.4; 427/307

(57) ABSTRACT

The present invention provides articles that exhibit exceptional peel strength and have a thermoplastic volume, a metal volume, and an interpenetrated volume that includes both thermoplastic and metal portions. The present invention also provides for methods of producing the articles of the invention.

### FIELD OF THE INVENTION

The present invention is in the field of metal plated thermoplastic compositions, particularly a high peel strength article comprising a thermoplastic-metal interpenetrated volume and a process for creating such an article.

### BACKGROUND OF THE INVENTION

Metal coated thermoplastic polymers (“TPs”) are utilized for numerous aesthetic purposes, such as chrome plating shower heads and automotive door handles. In addition, TPs provide improved functional performance in areas such as electromagnetic shielding. The metal may be coated onto the TP using a variety of methods, such as electrolysis or electroplating, vacuum metallization, different sputtering methods, lamination of metal foil onto the thermoplastic, or other commonly used methods.

Metal coating is most commonly carried out by surface treating and then “activating” the surface of the TP with a catalyst so that it may be electrolessly plated, and, optionally, coating the majority of the metal electrolytically. The surface treatment of the TP may involve mechanical and/or chemical “etching” of the surface, so as to allow electroless plating and/or allow and improve the adhesion of the metal layer to the TP surface. A typical method of treating the TP surface is to use a solution containing sulfuric and chromic (chromium VI) acids, which is often used to surface treat or etch TPs such as ABS, polyamides, including partially aromatic polyamides (“PAPs”).

The TP itself may determine the specific surface treatment needed. For instance, aliphatic polyamides, such as polyamide-6,6 and polyamide-6 may be treated by a variety of methods. However, PAPs, in which most or all of the dicarboxylic acid used to form the polyamide is an aromatic dicarboxylic acid, are often more resistant to chemical surface treatment.

Adhesion strength between the polymer and the metal is important so that the article can withstand prolonged performance without separation. Typical methods of improving the adhesion strength are known to include extractables, which are generally removed during the surface preparation to create cavities of varying dimensions and shapes, often appearing spherical or elongated and with narrowed openings facing the direction of metal deposition. Generally speaking, the metal coating should have sufficient adhesion so that it does not separate from the thermoplastic substrate during use.

### SUMMARY OF THE INVENTION

The present invention provides an article comprising: (a) a thermoplastic volume comprising a thermoplastic composition comprising a thermoplastic polymer, and, optionally, extractables and filler. At least a portion of the thermoplastic volume optionally comprises cavities; (b) a metal volume comprising at least one metal; and (c) an interpenetrated volume in between parts (a) and (b), and in contact with at least a portion of parts (a) and (b). The interpenetrated volume is comprised of the thermoplastic composition of part (a), the at least one metal of part (b), and cavities, wherein at least a portion of the cavities are at least partially filled with the at least one metal.

The present invention also provides methods of making an article comprising parts (a), (b), and (c). The method comprises: (a) providing a thermoplastic composition, wherein the thermoplastic composition comprises extractables; (b) creating cavities in the thermoplastic composition by at least partially removing the extractables; (c) providing a metal volume comprising at least one metal; and (d) creating an interpenetrated volume by filling or partially filling at least a portion of the cavities with the at least one metal.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention. However, the invention is not limited to the specific methods, compositions, and devices disclosed. In addition, the drawings are not necessarily drawn to scale. In the drawings:

FIG. 1 illustrates a schematic depiction of one embodiment of the invention.

FIG. 2 illustrates scanning electron microscopy (“SEM”) depiction of the cavities formed by etching Composition 1 in preparation for metallization.

FIG. 3 illustrates SEM depiction of Composition 1 coated with nickel-phosphorus metal alloy.

FIG. 4 illustrates transmission electron microscopy (“TEM”) of cryotomed cross section of an article prepared from Composition 1 having been coated with nickel-phosphorus metal alloy.

FIGS. 5A and 5B illustrate SEM of focused ion beam (“FIB”) cross sections of Comparative Example 1 and Example A, respectively.

FIGS. 6A and 6B illustrate SEM of FIB cross sections depicting Example A and Comparative Example 2, respectively.

FIG. 7 illustrates SEM of FIB cross sections depicting Example C.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, application, conditions or parameters described and/or shown herein, and that the terminology used herein is for the purpose of describing particular embodiments by way of example only and is not intended to be limiting of the claimed invention.

Also, as used in the specification, including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. Further, reference to values stated in ranges include each and every value within that range.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination.

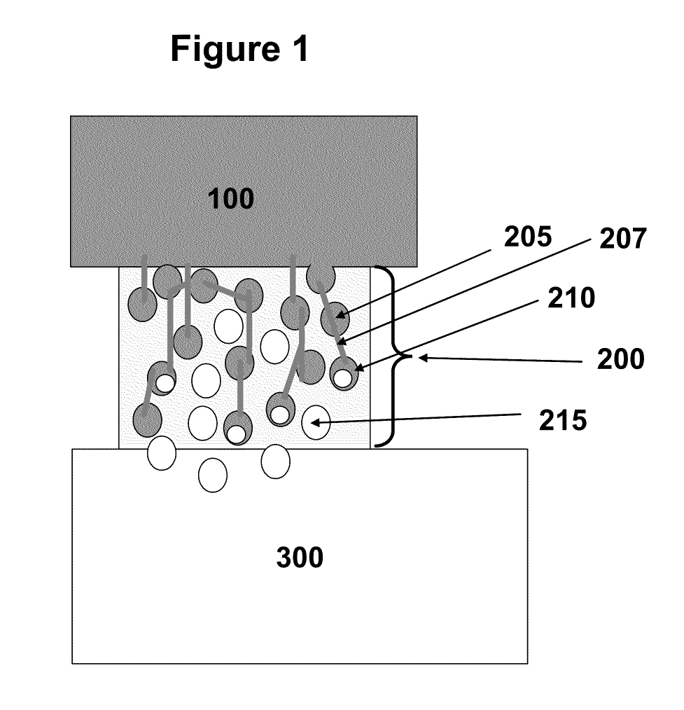

As depicted in FIG. 1, articles of the present invention comprise a metal volume 100, an interpenetrated volume 200, and a thermoplastic volume 300. As used herein, the term “volume” is a 3-dimensional shape made of a material via any method of forming the material, such as, for example, injection molding, stamping, compression molding, and compression-injection molding for thermoplastic polymers or thermoplastic compositions. Methods used for metals include electroplating, vacuum metalizing, and electrolessly plating. The metal volume may comprise more than one type of metal or metal alloy that may be deposited in one or more layers that at least partially contact one another.

A thermoplastic polymer (“TP”) is an organic polymeric material that is not crosslinked and which has a glass transition temperature (“Tg”) and/or melting point (“Tm”) above 30° C. Tm and Tg are measured using ASTM Method D3418-82. The Tm is taken as the peak of the melting endotherm, while the Tg is taken as the inflection point of the glass transition. To be considered a Tm, the heat of melting for any melting point should be at least 1.0 J/g.

TPs that are useful in the present invention include poly(oxymethylene) and its copolymers; polyesters such as PET, poly(1,4-butylene terephthalate), poly(1,4-cyclohexyldimethylene terephthalate), and poly(1,3-poropyleneterephthalate); polyamides such as nylon-4, nylon-6,6, nylon-6, nylon-10, nylon-11, nylon-12, and partially aromatic (co)polyamides; liquid crystalline polymers, such as polyesters and polyester-amides; polyolefins, such as polyethylene (including all forms such as low density, linear low density, or high density), polypropylene, polystyrene, polystyrene/poly(phenylene oxide) blends, polycarbonates, such as poly(bisphenol-A carbonate); acrylonitrile butadiene styrene; fluoropolymers, including perfluoropolymers, and partially fluorinated polymers, such as copolymers of tetrafluoroethylene and hexafluoropropylene, poly(vinyl fluoride), and the copolymers of ethylene and vinylidene fluoride or vinyl fluoride; polysulfones such as poly(p-phenylene sulfone), polysulfides such as poly(p-phenylene sulfide); polyetherketones, such as poly(ether-ketones), poly(ether-ether-ketones), and poly(ether-ketone-ketones); poly(etherimides); acrylonitrile-1,3-butandinene-styrene copolymers; thermoplastic (meth)acrylic polymers such as poly(methyl methacrylate); and chlorinated polymers, such as poly(vinyl chloride), vinyl chloride copolymer, and poly(vinylidene chloride).

Also included are thermoplastic elastomers, such as thermoplastic polyurethanes, block-copolyesters containing soft blocks, such as polyethers and hard crystalline blocks, and block copolymers, such as styrene-butadiene-styrene and styrene-ethylene/butadiene-styrene block copolymers. Additionally, included herein are blends of TPs, including blends of two or more semicrystalline or amorphous polymers, or blends containing both semicrystalline and amorphous thermoplastics.

Certain embodiments of the invention use semicrystalline TPs. A semicrystalline TP is a thermoplastic which has a melting point above 30° C., with a heat of melting of at least about 2.0 J/g, more preferably at least about 5.0 J/g. Semicrystalline TPs that may be used in the invention include polymers such as poly(oxymethylene) and its copolymers; polyesters such as poly(ethylene terephthalate), poly(1,4-butylene terephthalate), poly(1,4-cyclohexyldimethylene terephthalate), and poly(1,3-poropyleneterephthalate); polyamides, such as nylon-6,6, nylon-6, nylon-10, nylon-11, nylon-12, combinations thereof, and partially aromatic (co)polyamides; liquid crystalline polymers, such as polyesters and polyester-amides; polyolefins, such as polyethylene (all forms such as low density, linear low density, and high density), polypropylene, fluoropolymers, including perfluoropolymers, and partially fluorinated polymers, such as copolymers of tetrafluoroethylene and hexafluoropropylene, poly(vinyl fluoride), and the copolymers of ethylene and vinylidene fluoride, or vinyl fluoride; polysulfones, such as poly(p-phenylene sulfone), polysulfides, such as poly(p-phenylene sulfide); polyetherketones, such as poly(ether-ketones), poly(ether-ether-ketones), and poly(ether-ketone-ketones); and poly(vinylidene chloride). Also included are thermoplastic elastomers, such as thermoplastic polyurethanes, block-copolyesters containing soft blocks, such as polyethers, hard crystalline blocks, and block copolymers, such as styrene-butadiene-styrene and styrene-ethylene/butadiene-styrene block copolymers.

Polyamides are condensation products of one or more dicarboxylic acids, one or more diamines, one or more aminocarboxylic acids, and/or ring-opening polymerization products of one or more cyclic lactams. They may be fully aliphatic or semiaromatic. As used herein, polyamides are defined conventionally as composed of a mixture of polyamide molecules, each having many instances of one or more amide monomers, wherein the amide monomers of the polyamide molecules of the mixture make up most or all of each polyamide molecule by weight (for example greater than 80, 90, 95, or 99% with any remainder due to minor other materials as end groups, non-amide monomers, or the like, or 100%).

As used herein, an aliphatic polyamide is a polyamide derived from one or more aliphatic diamines, one or more dicarboxylic acids, one or more aliphatic lactams, and/or one or more aminocarboxylic acids, and their reactive equivalents provided that of the total dicarboxylic acid derived units present, less than 60 mole percent, more preferably less than 20 mole percent, and even more preferably essentially no units derived from aromatic dicarboxylic acids are present.

A suitable aminocarboxylic acid is 11-aminododecanoic acid. Suitable lactams include caprolactam and laurolactam. Carboxylic acid monomers comprised in the aliphatic polyamides are aliphatic carboxylic acids, such as for example adipic acid (C6), pimelic acid (C7), suberic acid (C8), azelaic acid (C9), sebacic acid (C10), dodecanedioic acid (C12) and tetradecanedioic acid (C14). Preferred aliphatic dicarboxylic acids include adipic acid, cebacic acid, and dodecanoic acid. As used herein, aliphatic diamines are compounds in which each of the amino groups is bound to an aliphatic carbon atom. Useful aliphatic diamines include diamines of the formula H₂N(CH₂)ₙNH₂, wherein n may be any number 4-14, and 2-methyl-1,5-pentanediamine. Preferred aliphatic diamines comprised in aliphatic polyamides include hexamethylene diamine, tetramethylene diamine, and decamethylene diamine.

As used herein, the term aliphatic polyamide also refers to copolymers derived from two or more such monomers and blends of two or more aliphatic polyamides. Linear, branched, and cyclic monomers may be used.

As used herein, “semiaromatic polyamides” and “partially aromatic polyamides” (“PAP”) are used interchangeably. They are polyamides derived in part from one or more aromatic dicarboxylic acids, where the total aromatic dicarboxylic acid is at least 50 mole percent. In certain embodiments of the invention, the total aromatic dicarboxylic acid is at least 80 mole percent. In another embodiment of the invention the total aromatic dicarboxylic acid is essentially all of the dicarboxylic acids from which the polyamide is derived. As used herein, aromatic dicarboxylic acids are compounds in which each of the carboxyl groups is bound to a carbon atom which is part of an aromatic ring. Useful dicarboxylic acids include terephthalic acid, isophthalic acid, 4,4″-biphenyldicarboxylic acid, and 2,6-naphthalenedicarboxylic acid. Preferred aromatic dicarboxylic acids are terephthalic acid and isophthalic acid, and their combinations. PAPs also comprise aliphatic diamines as defined above. Preferred aliphatic diamines comprised in PAPs include hexamethylene diamine and 2-methyl-1,5-pentanediamine.

As used herein, the term PAP also refers to copolymers derived from two or more such monomers and blends of two or more PAPs. Linear, branched, and cyclic monomers may be used.

Exemplary polyamides include various aliphatic polyamides, such as polyamide 6; polyamide 6,6; polyamide 4,6; polyamide 6,10; polyamide 6,12; polyamide 6,14; polyamide 6,13; polyamide 6,15; polyamide 6,16; polyamide 11; polyamide 12; polyamide 9,10; polyamide 9,12; polyamide 9,13; polyamide 9,14; polyamide 9,15; polyamide 6,16; polyamide 9,36; polyamide 10,10; polyamide 10,12; polyamide 10,13; polyamide 10,14; polyamide 12,10; polyamide 12,12; polyamide 12,13; and polyamide 12,14, individually or in combination. Preferred examples of aliphatic polyamides are poly(hexamethylene adipamide) (polyamide 66, PA66, also called nylon 66), commercially available under the trademark Zytel® from E. I. du Pont de Nemours and Company, Wilmington, Del., and polyamides 10,10 and 6,12.

Exemplary polyamides also include various PAPs, such as hexamethylene terephthalamide, hexamethylene isophthalamide, tetramethylene terephthalamide, 2-methyl pentamethylene terephthalamide, p-phenylene terephthalamide, and m-phenylene adipamide, m-xylene adipamide, dodecamethylene terephthalamide, dodecamethylene isophthalamide, decamethylene terephthalamide, decamethylene isophthalamide, nonamethylene terephthalamide, nonamethylene isophthalamide, 2-methylpentamethylene isophthalamide, caprolactam-hexamethylene terephthalamide, and caprolactam-hexamethylene isophthalamide, individually or in combinations thereof. Preferred PAPs are poly(hexamethylene isophthalamide), poly(hexamethylene terephthalamide), and poly(2-methyl pentamethylene terephthalamide). Any of the aliphatic polyamides described above and any of the PAPs described above may be used in combination with one another and in combinations among other aliphatic polyamides and PAPs.

Embodiments of the invention include TPs with a Tg and/or Tm of about 50° C. or more, about 80° C. or more, and about 120° C. or more. In a preferred embodiment of the invention, the TP is at least 30 weight percent of the total TP composition, preferably at least 40 weight percent of the total TP composition, and most preferably at least 45 weight percent of the total TP composition. Unless otherwise stated or indicated from other context, as used herein, the “TP composition” or “the total TP composition” means the composition comprising the TP before any of the treatments that result in altering its surface and before metallization and the formation of the interpenetrated volume. More than one TP may be present in the TP composition, and the amount of TP present is taken as the total amount of TPs present.

The thermoplastic composition may also comprise extractables. The “extractable” or “extractable component” is typically an inorganic or organic ingredient present in the TP composition. The extractable is at least partially removed from the TP composition leaving cavities in its place. The removal is done under conditions which do not significantly deleteriously affect the TP, although some limited swelling or other mechanism may occur at or near the surface of the TP composition that is treated, which may result in removal of some small portions of the TP, such as low molecular weight fragments, thereby forming finer or smaller cavities at the surface and/or up to a certain depth below the surface of the TP composition. Such conditions include acid, base, thermal, or solvent conditions. Although other methods may be used to form cavities in the thermoplastic composition, one embodiment is to use extractables as disclosed herein.

The extractable component may be removed partially or completely from the surface of the TP composition up to a depth that varies depending on the specific TP composition and the treatment applied. For example, cavities may be formed to a depth of 0.01, 0.1, 0.5, 1, 2, 10, 15, 20, 30, 40, or 50 microns, from the surface of the TP composition that is treated. In certain embodiments and applications, the cavities are formed to a depth of less than about 10 microns. In addition, some small portions of other components of the TP composition may be removed by the treatment, such as fragments of filler, for example glass, forming additional smaller/finer cavities. The cavities created from the removal or partial removal of extractables and other optional small components of the TP composition may be interconnected, forming interconnected cavity networks 207 as shown, for example, in FIG. 1. It may be desirable to have interconnected cavity networks to facilitate deeper penetration of the metal during metal deposition. The smaller/finer cavities may serve the role of interconnecting at least some of the larger cavities created by removal of the extractables.

The treatment applied for removal or partial removal of the extractable component may vary depending on the type of extractable component. For example, the extractable component may be material such as calcium carbonate or zinc oxide or various clays, ceramics, or their combinations. The extractable component may also be one or more various rubbers, which can be removed (etched) by aqueous hydrochloric acid, or a material such as zinc oxide or citric acid which may be removed by aqueous base, or materials such as poly(methyl methacrylate) which can be de-polymerized and removed at high temperatures, or citric acid or sodium chloride which can be removed by a solvent such as water. Since the TP will normally not be greatly affected by the treatment, usually only the extractable component near the surface of the TP composition will be affected, being either partially or completely removed.

The materials used as extractable components are determined by the conditions used for the etching, including the etchant (thermal, solvent, or chemical etchants), and the physical conditions under which the etching is carried out. For example, for any particular TP composition, etching should not be carried out at a temperature high enough to cause extensive thermal degradation of the TP, and/or the TP should not be exposed to a chemical agent which extensively attacks the TP, and/or to a solvent which readily dissolves the TP. Some compromise or damage to the TP may be acceptable, and indeed a small amount of etching of the TP itself may be useful in improving adhesion to the metal coating because of formation of smaller/finer cavities that may serve to form interconnected cavity networks.

Preferred extractable components are alkaline earth (Group 2 elements, IUPAC Notation) carbonates, with calcium carbonate being preferred. Preferably, the minimum amount of extractable components is 0.5 weight percent or more, more preferably about 1.0 weight percent or more, more preferably about 2.0 weight percent or more, and even more preferably about 5.0 weight percent or more based on the total thermoplastic composition. Typically, the maximum amount of extractable components present is about 30 weight percent or less, more preferably about 15 weight percent or less, and especially preferably about 10 weight percent or less based on the total thermoplastic composition. It is to be understood that any of these minimum weight percents can be combined with any of the maximum weight percents to form a preferred weight range for extractable components. More than one extractable component may be present, and if more than one is present, then the amount of extractable components is taken as the total of all such components present.

The TP composition may also optionally comprise a filler. As used herein “filler” can mean any filler or reinforcement component. For example, fillers may be any reinforcing fibers, such as carbon fibers, carbon nanotubes, aramid fibers, or glass fibers. They may have various shapes and dimensions, including short, long, chopped, continuous, spherical, or platelet. The fibers may be natural or synthetic. In certain embodiments of the invention, the fiber is chopped glass fiber in which the maximum average length of the fibers is about 1 mm to about 20 mm. In another embodiment, the length is from about 2 mm to about 20 mm.

In certain embodiments of the invention, the largest cross-sectional dimension of the fiber is less than about 20 μm. The fiber may be round or flat, and may be uncoated or coated with substances to promote adhesion to the TP matrix. As used herein, flat reinforcing fibers (“FRFs”) is a fiber having a noncircular cross-section, with the aspect ratio of the cross section being about 1.5 or more, or more preferably about 2.0 or more. The cross-sectional shape may be elliptical, oval, rectangular, or triangular.

The filler present in the TP composition used in the articles of the present invention is a minimum of at least about 5 weight percent, preferably at least about 10 weight percent, and more preferably at least about 20 weight percent, based on the total TP composition. The filler is 70 weight percent or less, preferably 50 weight percent or less, and more preferably 40 weight percent or less of the total TP composition. Any minimum concentration may be combined with any preferred maximum concentration for a preferred concentration range for the filler. More than one filler may be present in the TP composition, and the amount of filler present is taken as the total amount of filler(s) present.

Other ingredients may optionally be present in the TP composition. These include other ingredients typically found in TP compositions, such as fillers and reinforcing agents (other than above), tougheners, pigments, coloring agents, stabilizers, antioxidants, lubricants, flame retardants, and adhesion promotion agents other than the extractable components.

The TP compositions may be made by those methods that are well known in the art. Most commonly, the TP will be melt-mixed with the various ingredients in a suitable apparatus, such as a single or twin screw extruder or a kneader. In order to prevent extensive degradation of the reinforcing fiber length, it may be preferable to side feed the fiber, so the fiber is not exposed to the high shear of the entire length of the extruder.

The TP composition (before surface treatment and metal coating) may be formed by conventional methods for TP compositions, such as injection molding, extrusion, blow molding, thermoforming, and rotomolding. These methods are well known in the art. A preferred method is injection molding.

As used herein, the thermoplastic volume is that part of the thermoplastic composition that is not penetrated by metal and/or in contact with the metal. For example, this is the material below the interpenetrated volume (as depicted, for example, in FIG. 1) and typically includes a majority of the thermoplastic composition. As shown in FIG. 1, the thermoplastic volume 300 may have unfilled cavities. It is preferred that such unfilled cavities be limited in number and be in close proximity to the interpenetrated volume. Unfilled cavities in the thermoplastic volume may otherwise serve to weaken the peel strength of the article. The TP volume may also include un-removed extractables, fillers, and optional components as described herein.

The articles of the present invention also comprise a metal volume 100. As used herein, the metal volume comprises one or more types of metal, metal alloy, metal matrix composition, or combinations thereof that may be deposited in one or more layers that at least partially contact one another. It is possible, and often desirable for the metal volume to optionally comprise several layers of different metals, metal alloys, metal matrix compositions, or combinations thereof, in order to achieve a desired performance or combination of performance requirements. For example, an inner layer may need to be softer or more ductile, and therefore may comprise metals such as copper. There may be a need for a stiffer outer layer due to load bearing requirements, wherein metals such as nickel, nickel-iron, or similar strength metal alloys may be used. Often, an aesthetic layer of chrome or other aesthetic metal on the outer visible surface of the metal volume is desirable.

Any metal that may be electrolessly deposited or electroplated may be used in the metal volume of the articles of the present invention. Useful metals include copper, nickel, cobalt, iron, tin, and zinc. Alloys of these metals, such as nickel-iron, nickel-phosphorous, nickel-boron, cobalt-phosphorous, copper-phosphorous, copper-boron, copper-nitrogen, or combinations thereof, may also be plated. The resulting electroplated metal layer may have an average metal grain (crystallite) size in the range of 1 to 15,000 nm. One embodiment of the invention has an average grain size of 1 to 200 nm. Another embodiment of the invention has an average grain size of 1 to 100 nm. The total thickness of the coated metals in one embodiment of the invention is about 1 to about 200 μm. The total thickness of the coated metals in another embodiment of the invention is from about 1 to about 100 μm.

Useful metal coating methods include electrolytic and electroless coating. The metal coatings can comprise at least one metal in elemental form, alloys of such metals, or metal matrix composites. The coatings can be more than 0.01, 5, 10, 25, 50, or 200 μm thick, and are typically less than 0.1, 1, or 10 cm thick.

In a typical metal plating of a plastic material, such as a thermoplastic PAP, the surface of the PAP is cleaned and then surface treated. Alternatively, these two steps may be combined, or performed simultaneously. This surface treatment, also called surface preparation, is typically done by using an acidic material, such as sulfochromic acid and/or another acidic material, such as hydrochloric acid or sulfuric acid. The surface treatment results in removal or partial removal of extractables from near the surface of the TP composition, and also in optional removal of some small portions, such as low molecular weight TP fragments or portions of filler, for example glass, thereby forming smaller/finer cavities at the surface and/or to a depth below the surface of the TP composition. As noted herein, and shown in FIG. 1, the cavities may form interconnected cavity networks 207 within the TP composition, and the networks may facilitate deeper penetration of the metal during metal deposition.

The thermoplastic composition comprising the cavities and interconnected cavity networks is treated with a catalyst, typically a palladium compound, followed by the electroless plating solution, which deposits a layer of metal such as nickel or copper into at least a portion of the cavities in the thermoplastic composition filling or partially filling the cavities and/or the interconnected cavity networks, to create the interpenetrated volume (described below). This step also optionally deposits a first metal layer of the metal volume on top of the interpenetrated volume. Preferably, very few un-filled cavities remain below the interpenetrated volume and within the TP volume. In certain embodiments, different metals may be deposited to fill the cavities and interconnected network of cavities to create the interpenetrated volume.

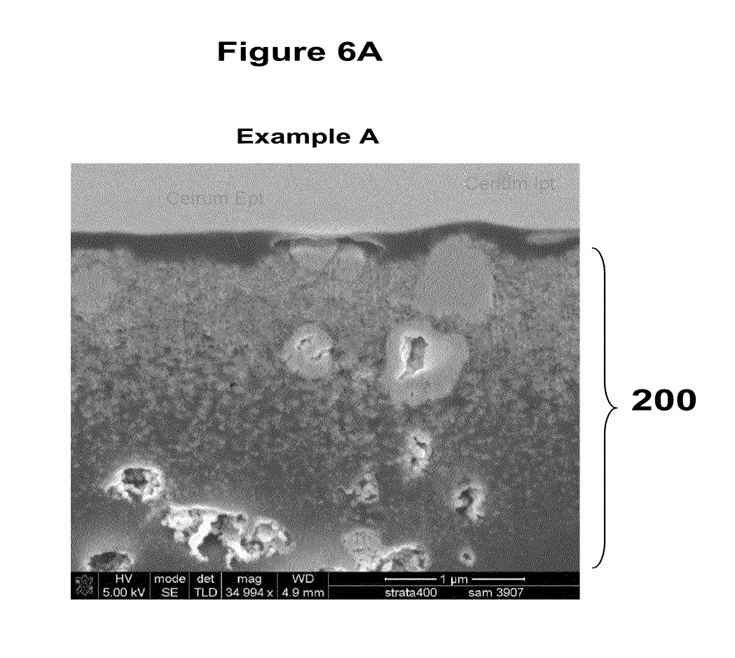

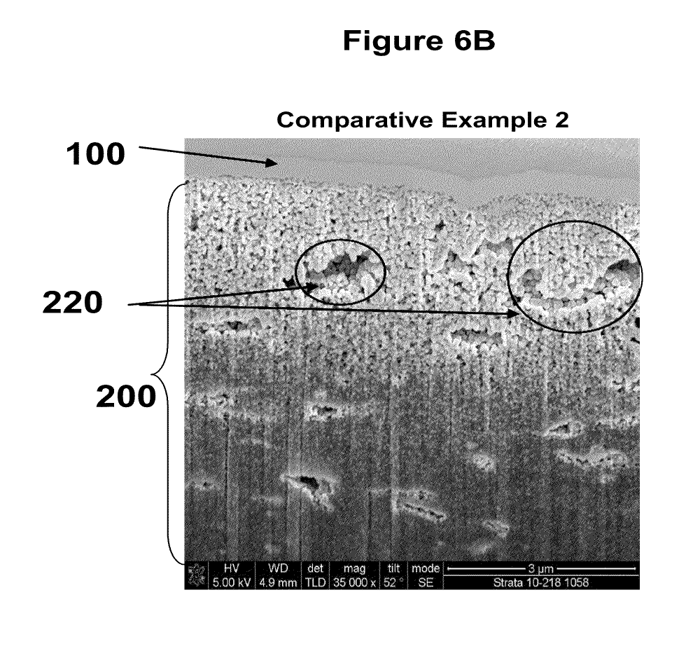

Electroless metal deposition is typically used for deposition of the first metal layer that fills or partially fills the cavities in the interpenetrated volume. Electroless deposition is accomplished through chemical reactions, typically involving the evolution of hydrogen gas and optionally other volatiles. The rate of metal deposition determines the volume of volatiles produced in unit time. If this rate is too high, the interconnected cavity network may be altered due to collapsing of the material of TP composition that separates the cavities as the volatiles rapidly make their way to the surface. As a result, as depicted in FIG. 6B, some cavities “collapsing” onto one another create larger cavities 220. And if the deposition rate is fast enough that these larger “collapsed” cavities 220 remain mostly unfilled, they are left behind as voids that may serve as flaws that negatively affect the peel strength of the article.

The electroless deposition may be the end of the process, or if a thicker and/or different metal layer is desired, the surface may be electroplated in a conventional manner. If the TP composition is electrically conductive, then electroless plating may not be needed, and only electroplating may be done.

Referring to FIG. 1, the interpenetrated volume 200 of the articles of the present invention is located between the thermoplastic volume 300 and the metal volume 100 and in contact with at least a portion of the thermoplastic volume and a portion of the metal volume. The interpenetrated volume is a volume that comprises both metal and TP composition material.

In one embodiment, the interpenetrated volume is created during the process of metal coating the TP composition, by first creating cavities from, for example, removal of extractables during surface preparation steps (the preparation steps may comprise an etching step with acid or base and/or sweller combinations), and then by filling or partially filling at least some of the cavities with the metal during metal deposition. It may be that some of the cavities at certain depths from the treated surface of the TP composition are not filled by the metal and such unfilled cavities may be left in the TP volume 300 that contacts the interpenetrated volume 200 which, in turn, contacts the metal volume 100.

Cavities are typically located in the portion of the TP volume closest to the interpenetrated volume, as well as in the interpenetrated volume. The cavities are typically the shape of the removed extractable, or the removed portion of the extractable, or of any other part of the TP composition that may be removed during surface treatment or preparation. They may be spherical or near spherical, irregularly shaped, or elongated. They may have roughness or partial roughness, or they may be smooth or partially smooth. Typically, the cavities are the size of the part of the extractable or of any other part of the TP composition that was removed, and can range from, for example, about 0.1 micron to about 10.0 microns, and preferably less than 2 microns (in at least two dimensions) for the larger cavities, whereas the smaller/finer cavities that serve to interconnect the larger cavities may be smaller than 0.1 microns (in at least two dimensions).

A greater number of cavities in the interpenetrated volume results in higher peel strength for the article to the extent they are filled or partially filled with metal. It is also desirable to form interconnected cavity networks, as described herein, because such networks form pathways that enable the metal to deposit into the deeper cavities. It is generally undesirable to have the large “collapsed” cavities that may be formed from too fast deposition rates, because these cavities are difficult to fill before the pathways to them are blocked by the deposition of metal in the treated areas of the thermoplastic composition closest to the metal source/metal volume. Such unfilled, large “collapsed” cavities weaken the peel strength of the article.

Overall, the larger the number of cavities filled or partially filled with metal in the interpenetrated volume, the higher the peel strength. In a preferred embodiment of the present invention, at least 50% of the cavities in the interpenetrated volume are filled or partially filled with metal. In a more preferred embodiment of the invention, less than 10% of the cavities in the interpenetrated volume remain unfilled or partially unfilled with metal. An exemplary peel strength obtained in one embodiment of the invention is at least 10 N/cm.

It is generally undesirable to have a large number of unfilled cavities in the TP volume, as such cavities in the TP volume reduce the strength of the TP composition. Hence, it is beneficial to have a greater concentration of cavities in the interpenetrated volume of the article, but not in the TP volume. In order to accomplish this, it is desirable to slow the metal deposition rate in order to extend the deposition time to fill each cavity to near completeness, and to allow access to the cavities that are deeper within the treated portion of the TP composition such that a deeper interpenetrated volume will be formed. If the cavities and the interconnected cavity networks in the TP composition closest to the metal source or metal volume fill too fast, then the path to the deeper cavities becomes blocked and the metal does not reach them and they remain unfilled, thereby causing a reduced peel strength.

In certain embodiments, the metal present in the interpenetrated volume is deposited at a rate of no more than 100 micrograms/cm² min, preferably no more than 90 or 80 micrograms/cm² min, and more preferably no more than 70 micrograms/cm² min. Additionally, the type of metal or metal alloy may affect the deposition rate and the time of deposition needed to achieve sufficient filling of the cavities.

Certain embodiments of the invention have at least 50% of the cavities at least partially filled with metal in the interpenetrated volume. Some preferred embodiments have about 90%, 80%, 70%, or 60% of the cavities in the interpenetrated volume substantially filled with metal. Other embodiments have fewer than 20%, 10%, or 5% of unfilled cavities in the TP volume.

As can be seen in the present description, factors such as size of cavities, location of cavities, number of cavities, and extent of cavity fill, as well as the deposition rate of the metal present in the interpenetrated volume may have an effect on peel strength of the article. Although not all such factors may be readily quantified, preferred combinations of such factors are those that lead to peel strengths of at least 10 N/cm, and more preferably of at least 15 N/cm, the peel strength being the force needed to peel the metal volume from the article.

Although relative dimensions will depend on the particular article and/or application of the article, example cross-sectional thicknesses of the metal volume in a typical article may be from about 10, 20, or 30 microns to about 100, 200, or 300 microns, with a preferred range being about 30 microns to about 100 microns. The cross-sectional thickness of the TP volume may be from about 0.1, 0.3, or 0.5 mm to about 2, 4, or 10 mm, with a preferred range being from about 0.3 to about 4 mm. The interpenetrated volume will typically have the smallest relative thickness dimension and may have a cross-sectional thickness from about 0.01, 0.05, or 0.1 microns to about 1, 2, or 10 microns, with a preferred range being from about 1 to about 2 microns.

Various composite articles and electronic devices may comprise articles of the invention. Electronic devices may include cell phones, personal digital assistants, music storage devices, listening devices, portable video players, electrical multimeters, mobile electronic game consoles, or mobile personal computers.

### EXAMPLES

The present invention is further described and exemplified in the following examples. It should be understood that these examples are given by way of illustration only. Essential characteristics of this invention may be ascertained from the above discussion in combination with the examples, and various modifications may be made without departing from the spirit and scope of the invention disclosed herein.

### Composition 1

Thermoplastic Composition 1 was composed of 34.15 parts polyamide 6,6 (“PA66”) made of 1,6-diaminohexane and 1,6-hexanedioic acid; 15 parts amorphous polyamide B composed of 1,6-diaminohexane, 70 mole percent isophthalic acid, and 30 mole percent terephthalic acid (mole percents based on total amount of dicarboxylic acids present in polyamide B); 0.40 parts Chimassorb 944, also known as poly[(6-[1,1,3,3-tetramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]]); 0.20 parts Irganox 1098, also known as 3,3′-bis(3,5-di-tert-butyl-4-hydroxyphenyl)-N—N′-hexamethylenedipropionamide; 0.25 parts LICOMONT® CAV 102, a calcium salt of montanic acid crystallization promoter, available from Clariant GmbH, Augsburg, Germany; 10 parts SUPER-PFLEX 200, a surface-treated, fine particle size, precipitated calcium carbonate with narrow particle size distribution available from Specialty Minerals, Incl., Bethlehem, Pa., having a typical 2% stearic acid surface treatment, average particle size 0.7 microns, +325 mesh residue of 0.03 weight percent, and surface area of 7 meters²/gram; 40 parts flat glass fibers, namely NITTOBO CSG3PA-820, 3 mm long, 28 microns wide, 7 microns thick, aspect ration of cross-sectional axes equaling 4, having aminosilane sizing, from NITTO BOSEKI, Japan.

Pellets of Composition 1 were prepared by melt blending the components in order as shown in an extruder, where the glass was fed into the molten polymer matrix with a side feeder. Pelletizing temperature was approximately 280° C. to 310° C. Upon exiting the strand die, they were quenched in water and pelletized. The pellets were approximately 3 mm in diameter and 5 mm in length. The prepared pelletized composition was then dried at 100° C. for 6-8 hours in a dehumidified dryer, and then molded into a standard ISO 294 type D2 plaque of 6 cm×6 cm×2 mm, at a melt temperature of 280° C. to 300° C., and a mold temperature of 85° C. to 105° C.

### Composition 2

Thermoplastic Composition 2 was composed of 49 parts PA66; 0.40 parts Chimassorb 944; 0.20 parts Irganox 1098; 0.25 parts LICOMONT® CAV 102; 10 parts SUPER-PFLEX 200; 40 parts glass fibers, namely PPG 3540 of nominal length 3.2 mm, available from PPG Industries, Pittsburgh, Pa.

Pellets of thermoplastic Composition 2 were prepared by melt blending as for Composition 1. The pelletizing temperature was approximately 310° C. to 330° C. Plaque specimens were analogously prepared at a melt temperature of 280° C. to 310° C., and a mold temperature of 90° C. to 110° C.

### Composition 3

Thermoplastic Composition 3 was composed of 47.3 parts polyamide made from terephthalic acid, 50 mole percent (of the total diamine present) of 1,6-hexanediamine, and 50 mole percent of 2-methyl-1,5-pentanediamine; 2 parts PA66; 0.40 parts of HS triblend 7:1:1; 0.25 Licowax OP; 10 parts SUPER-PFLEX 200; and 40 parts glass fibers, namely PPG 3660 of nominal length 3.2 mm, available from PPG Industries, Pittsburgh, Pa.

Pellets of thermoplastic Composition 3 were prepared by melt blending as for Composition 1. The pelletizing temperature was approximately 330° C. to 345° C. The plaque specimen were analogously prepared at a melt temperature of 310° C. to 330° C., and a mold temperature of 140° C. to 160° C.

### Comparative Examples

Articles of the present invention and comparative examples were prepared by creating cavities at and near the surface of the molded plaques of thermoplastic Compositions 1, 2, and 3 by exposing the plaques to a series of surface preparation steps. This was followed by metal deposition by filling or partially filling at least some of the cavities with a Ni—P metal composition, thereby creating the interpenetrated volume. Additional metal deposition steps creating the metal volume of a first Ni—P layer electrolessly deposited, and a second layer of Cu was galvanically deposited.

### Process 1

The surface of the plaque was prepared by etching for 12-13 minutes at 41° C.-43° C., with 1.2 to 1.33 (Eq H+)/L HCl in ethylene glycol. Additional etchant ingredients included PM-847 at approximately 230 to 270 mL/L, where PM-847 is about 22.5 weight percent calcium chloride and about 13.75 weight percent hydrogen chloride, obtained from Rohm and Haas Company, Philadelphia, Pa. This was followed by a water rinse for 2 minutes at room temperatures, then an ultrasonic water rinse for 5-15 minutes at room temperature. This was followed by a water rinse for 1 minute at room temperature.

The surface preparation steps were followed by activation with a solution of 150 ppm palladium ions with mechanical stirring for 5-10 minutes at 30° C., then a water rinse for 2 minutes at room temperature. This was followed by acceleration with an aqueous solution of accelerator for 1-3 minutes at 30° C., then a water rinse for 2 minutes at room temperature.

The interpenetrated volume and the first layer of the metal volume were created by electroless nickel deposition for about 10 minutes at about 35° C. to 40° C., while pumping the plating solution, followed by a water rinse for 1 minute at room temperature. This was followed by galvanic deposition of the second metal layer of the metal volume, about a 20 micron thickness of metallic copper from aqueous copper sulphate for 40 minutes at room temperature with mechanical stirring, followed by a water rinse for 1 minute at room temperature, and finishing by drying the article.

### Process 2

The surface preparation steps of Process 1 were performed and were followed with additional surface preparation steps of immersion in a 5% ammonium hydrogen bifluoride HNH₄F₂ solution in H₂O for about 5 minutes at about 15° C.-25° C., followed by a drip dry for 1 minute. This was followed by a water rinse for about 5 minutes at room temperature, followed by an additional water rinse for about 1 minute.

The surface preparation steps were followed by activation with a solution of palladium ions for about 4-7 minutes at 30° C.-40° C., followed by a drip dry for about 1 minute, followed by a water rinse for about 1 minute at room temperature. This process was followed by acceleration with an aqueous solution of accelerator (Atotech Noviganth PA Reducer, from Atotech Deutschland GmbH) for 2-4 minutes at 40° C. to 55° C., followed by a drip dry for about 1 minute. This process was followed by a water rinse for 1 minute at room temperature. The interpenetrated volume and first layer of the metal volume were created by electroless nickel deposition for about 10 minutes at 53° C.-57° C., while agitating the plating solution with air, followed by a water rinse for about 1 minute at room temperature. This was followed by galvanic deposition of the second metal layer of the metal volume as in Process 1.

### Processes 3 and 4

The surface preparation steps of Process 1 were performed and were followed with additional surface preparation steps of immersion in an aqueous solution of ammonium hydrogen bifluoride HNH₄F₂, at 80 g/L at room temperature for 5 minutes, followed by 2 water rinses for about 2 minutes at room temperature. The activation and acceleration was as in Process 1. The interpenetrated volume and the first and second layers of the metal volume were created as in Process 1, with the exception that in Process 4, the electroless nickel plating was carried out for 30 minutes.

### Process 5

The surface preparation steps included immersion in sulfochromic acid at about 70° C.-80° C. for about 10 minutes followed by 4 water rinses for about 1 minute each at room temperature, then a neutralization step for 2-5 minutes at 55° C. (in PM955 solution, available from Dow), followed by a water rinse for 1 minute at room temperature, then immersion in a solution of ammonium hydrogen bifluoride HNH₄F₂, at 80 g/L at room temperature for 5 minutes. This was followed by a water fines for 2 minutes at room temperature, then a dip in 10% HCl for 0.5 minutes at room temperature. Activation followed, with a solution of Conductron® DP, which includes 35 ppm Pd, with mechanical stirring for 5-10 minutes at 30° C., followed by a water rinse for 2 minutes at room temperature, followed by acceleration with an aqueous solution of accelerator (PM-864) for 2-10 minutes at 45° C., followed by a water rinse for 1 minute at room temperature. The interpenetrated volume and the first and second layers of the metal volume were created as in Process 4.

The peel strength of the metal volume from the article made from Compositions 1, 2, and 3 was measured by a Z005 tensile tester (Zwick USA LP, Atlanta, Ga.) with a load cell of 2.5 kN using ISO test method 34-1. A metal coated plaque prepared according to each example and comparative example was fixed on a sliding table was attached to one end of the tensile tester. Two parallel cuts, 1 cm apart, were made into the metal surface so that a band of metal 1 cm wide was created. The table slid in a direction parallel to the cuts. The 1 cm wide metal strip was attached to the other end of the machine, and the metal strip was peeled, at a right angle, at a test speed of 50 mm/min at 23° C. and a relative humidity of 50%. The peel strengths of each example and comparative example are shown in Table 1.

TABLE 1

| | | | Peel |
|---|---|---|---|
| | Thermoplastic | | Strength |
| Examples | composition | Process | N/cm |
| Comparative | Composition 1 | Process 1 | 5.7 |
| 1 | | | |
| Comparative | Composition 1 | Process 2 | 4.2 |
| 2 | | | |
| Example A | Composition 1 | Process 3 | 16.9 |
| Example B | Composition 1 | Process 4 | 21.9 |
| Example C | Composition 2 | Process 4 | 35.4 |
| Example D | Composition 3 | Process 5 | 11.0 |

The rate of electroless NiP deposition was measured by measuring the weight before and after the electroless deposition of NiP in the corresponding processes for each of Example A, B, E, and F and for Comparative Example 2, then reporting the difference as the weight of NiP electrolessly deposited, then dividing this weight by the time of the electroless deposition. In the cases of Comparative Example 2 and Examples A and E, the time of the deposition was 10 minutes and the NiP weight electrolessly deposited was 159.5, 53.5, and 93.5 micrograms/cm² min, respectively. For Examples B and F, the time of the deposition was 30 minutes and the NiP weight electrolessly deposited was 44.8 and 65.5 micrograms/cm² min, respectively. It is therefore desirable to practice a relatively slow rate of electroless metal deposition.

The significance of the electroless process in the context of this set of examples is that the electrolessly deposited metal is the first layer of deposited metal and the metal that fills the holes. A slower rate of deposition allows for better filling of the cavities, as seen, for example in the figures of Example A and the values provided for Example B. In contrast, the figure of the Comparative Example 2 (see FIG. 6B) illustrates that a faster rate of deposition of the first metal layer leaves many of the cavities unfilled and causes the “collapse” of many of the cavities to large unfilled cavities, thereby creating weak areas and resulting in low peel strength.

The rate of deposition correlates to the peel strength as shown in Table 2, but the correlation is not linear, accounting for the fact that it is the rate of deposition while the cavities are filled with metal that is an important factor. At some point in the metal deposition process, access to cavities that are deeper in the interpenetrated volume becomes blocked because of the already deposited metal near the surface. The metal continues to deposit on top of the interpenetrated volume, forming the first layer of the metal volume. The deposition of metal continues until this process step is stopped, meaning the specimen is removed from the solution. The deposition rate of filling the cavities may not be identical to the deposition rate that forms the first metal layer, but if the first metal layer is thin enough, in the order of 1 to 2 microns, the deposition rate of filling the cavities may be approximated by the overall rate of deposition of the first metal layer.

TABLE 2

| | | | Electroless NiP | |
|---|---|---|---|---|
| | | | Deposition rate | Peel |
| | Thermoplastic | | micrograms/cm² | Strength |
| Examples | composition | Process | min | N/cm |
| Comparative 2 | Composition 1 | Process 2 | 159.5 | 4.2 |
| Example A | Composition 1 | Process 3 | 53.5 | 16.9 |
| Example E | Composition 1 | Process 3 | 93.5 | 10.4 |
| Example B | Composition 1 | Process 4 | 44.8 | 21.9 |
| Example F | Composition 1 | Process 4 | 65.5 | 19.0 |

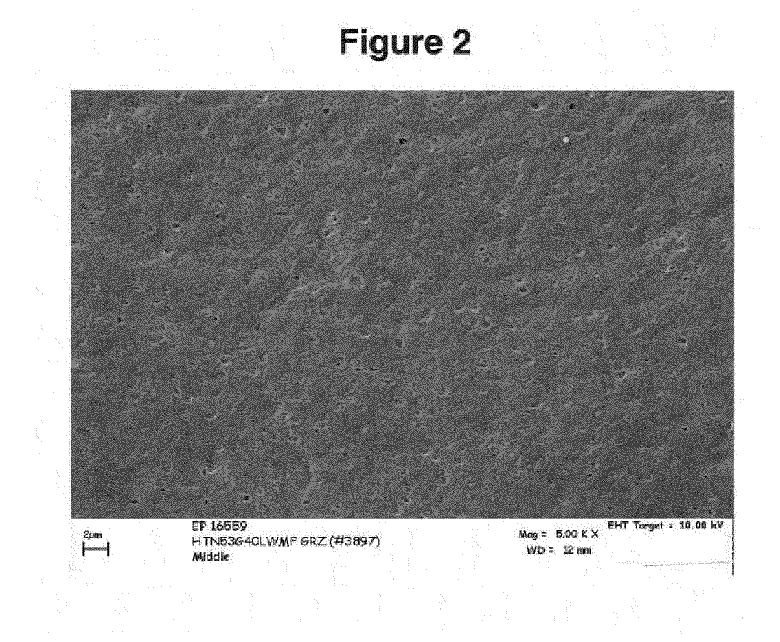

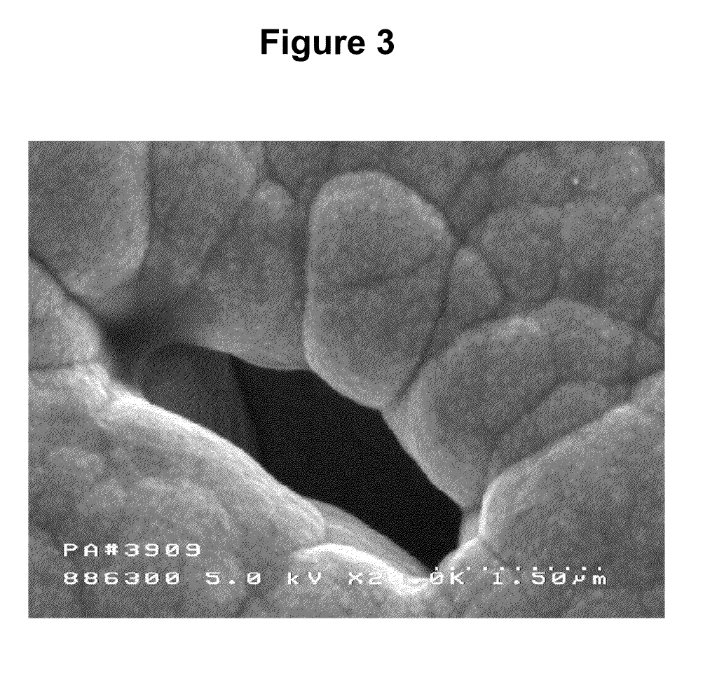

FIG. 2 depicts SEM of the surface of Composition 1 prior to metallization and the cavities formed at the surface. FIG. 3 depicts SEM of Composition 1 coated with a nickel-phosphorous metal alloy using process 1. As reflected in the figure, the metal may tend to conform to the outline of the cavities and some cavities do not fill completely with metal as shown in the figure.

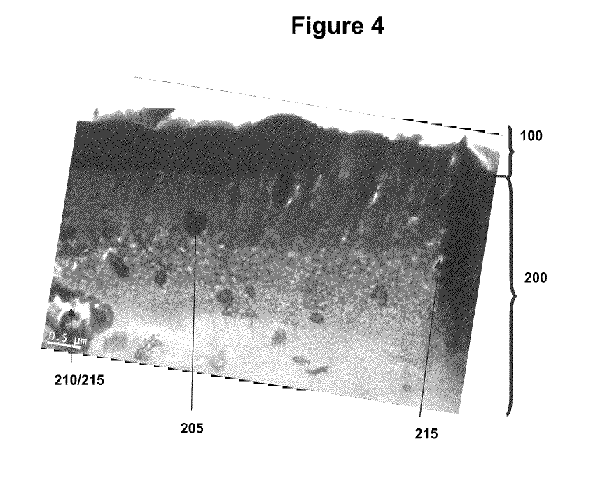

FIG. 4 depicts TEM of the cryotomed cross section of Composition 1 having been coated with a nickel-phosphorous metal alloy using process 1. The figure shows that some of the cavities 205 in the interpenetrated volume 200 are completely filled with metal, whereas some of the cavities 210 and 215 are partially filled or unfilled with metal.

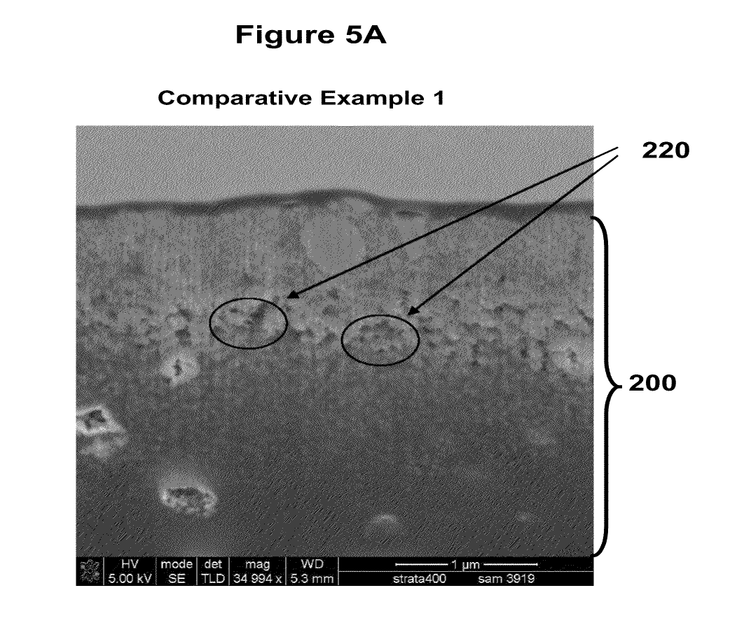

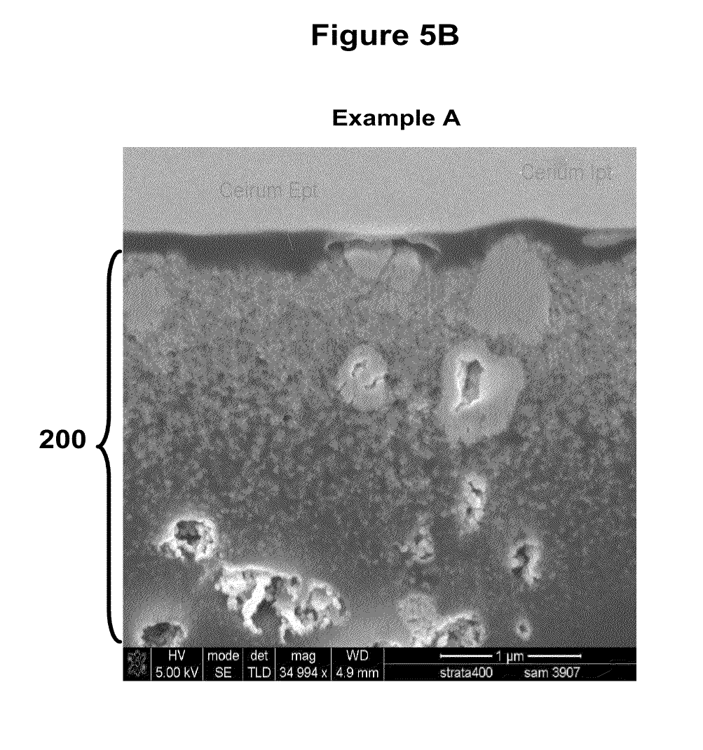

FIGS. 5A and 5B compare the SEM of FIB cross sections of Comparative Example 1 with Example A, respectively. As shown in the figures, more filled cavities, and better filling of deeper cavities, in the interpenetrated volume 200 of Example A result in a higher peel strength (16.9 N/cm) than Comparative Example 1 (5.7 N/cm). For example, a faster deposition rate utilized for Comparative Example 1 causes some cavities to “collapse” into larger, unfilled cavities 220 that reduce peel strength.

FIGS. 6A and 6B compare the SEM of FIB cross-sections of Example A and Comparative Example 2, respectively. Substantially more cavities remain unfilled in the interpenetrated volume 200 of Comparative Example 2, including the collapsing of cavities into large unfilled cavities 220. For example, the faster deposition rate (159.5 micrograms/cm² min) for Comparative Example 2, compared to the 53.5 micrograms/cm² min for Example A is shown to correlate to a lower peel strength (4.2 N/cm compared to 16.9 N/cm).

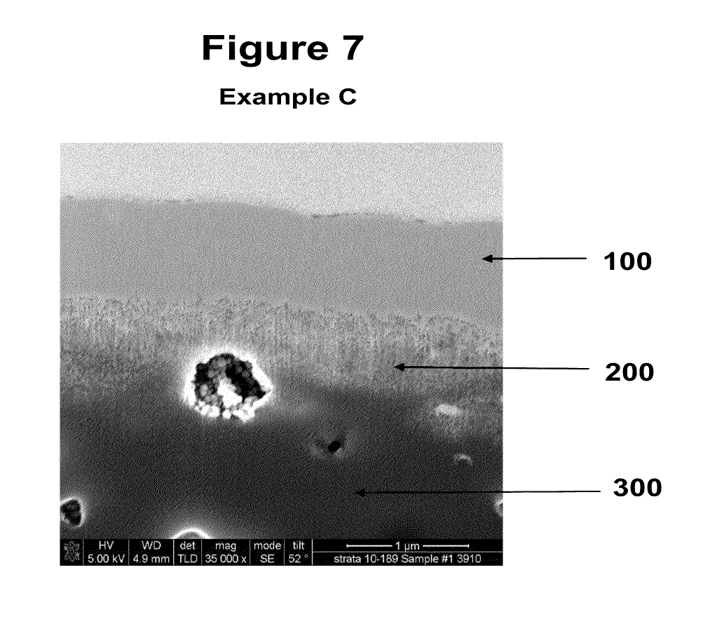

FIG. 7 depicts the SEM of FIB cross-sections of Example C. As shown in the figure, most of the cavities in the interpenetrated volume 200 are filled or substantially filled with metal and the absence of collapsed cavities correlates to a high peel strength of 35.4 N/cm with failure inside the TP volume.

What is claimed:

1. An article comprising:
(a) a thermoplastic volume comprising a thermoplastic composition comprising a thermoplastic polymer;
(b) a metal volume comprising at least one metal; and
(c) an interpenetrated volume in between (a) and (b) in contact with at least a portion of (a) and (b), said interpenetrated volume comprising the thermoplastic composition of (a), the at least one metal of (b), and cavities, wherein at least a portion of said cavities are at least partially filled with said at least one metal.

2. The article of claim 1, having a peel strength of at least 10 N/cm.

3. The article of claim 1, wherein at least 50% of the cavities of part (c) are at least partially filled with metal.

4. The article of claim 1, wherein part (b) has a thickness of at least 0.1 micron.

5. The article of claim 1, wherein part (c) has a thickness of at least 0.1 micron.

6. The article of claim 1, wherein said thermoplastic polymer is a polyamide.

7. The article of claim 6, wherein said polyamide is an aliphatic polyamide, a partially aromatic polyamide, or a combination thereof.

8. The article of claim 7, wherein said polyamide comprises hexamethylene adipamide (polyamide 6,6), poly(hexamethylene isophthalamide), or poly(hexamethylene terephthalamide), or a combination thereof.

9. A composite article comprising the article of claim 1.

10. An electronic device comprising the article of claim 1.

11. The electronic device of claim 10, wherein said electronic device is a cell phone, personal digital assistant, music storage device, listening device, portable video player, electrical multimeter, mobile electronic game console, or mobile personal computer.

12. The article of claim 1, wherein the metal volume of part (b) comprises a first metal layer comprising the at least one metal, a metal alloy, a metal matrix composition, or a combination thereof, and optionally at least one additional metal layer comprising at least one metal, metal alloy, metal matrix composition, or combination thereof.

13. The article of claim 12, wherein the metal of any said layer comprises Ni, NiP, NiB, Cu, NiFe, CoP, CuP, CuB, CuN, Sn, or combinations thereof.

14. The article of claim 12, having a thickest metal layer with a grain size less than 200 nm.

15. The article of claim 12, wherein said first metal layer is at least about from 0.01 μm to about 10.0 μm thick.

16. The article of claim 12, wherein said optional at least one additional metal layer is at least about from 10 μm to about 200 μm thick.

17. The article of claim 12, wherein the first metal layer is in contact with at least a portion of said at least one additional metal layer.

18. A method of making an article of claim 1 comprising:
(a) providing a thermoplastic composition, said thermoplastic composition comprising a thermoplastic polymer, extractables, and optionally filler;
(b) creating cavities in said thermoplastic composition by at least partially removing the extractables;
(c) providing a metal volume comprising at least one metal; and
(d) creating an interpenetrated volume by filling or partially filling at least a portion of the cavities with said at least one metal.

19. The method of claim 18, wherein said cavities are created by at least partially removing said extractables by first immersing said thermoplastic composition in an acidic solution followed by immersing in a fluoride solution.

20. The method of claim 18, wherein said metal present in the interpenetrated volume is deposited at a rate of no more than 100 micrograms/cm² min.
